(19) United States
(12) Patent Application Publication
(10) Pub. No.: US 2023/0319369 A1
(43) Pub. Date: Oct. 5, 2023

(54) VIDEO QUALITY ESTIMATION APPARATUS, VIDEO QUALITY ESTIMATION METHOD, AND VIDEO QUALITY ESTIMATION SYSTEM

(71) Applicant: NEC Corporation, Minato-ku, Tokyo (JP)

(72) Inventors: Anan SAWABE, Tokyo (JP); Takanori IWAI, Tokyo (JP)

(73) Assignee: NEC Corporation, Minato-ku, Tokyo (JP)

(21) Appl. No.: 18/021,293

(22) PCT Filed: Aug. 26, 2020
(86) PCT No.: PCT/JP2020/032174

§ 371 Date: Feb. 14, 2023

(51) Int. Cl. H04N 21/647; H04N 21/24

(52) U.S. Cl. CPC H04N 21/64738; H04N 21/2402; H04N 21/6473; H04N 21/64776; H04N 21/64792

(57) ABSTRACT

A video quality estimation apparatus (100) according to the present disclosure includes a first collection unit (101) configured to collect network quality information about a network pertaining to distribution of a video, a second collection unit (102) configured to collect video quality information about the video, and an estimation unit (103) configured to estimate a first bit rate corresponding to a resolution of the video based on the network quality information and the video quality information.

### TECHNICAL FIELD

The present disclosure relates to a video quality estimation apparatus, a video quality estimation method, and a video quality estimation system.

### BACKGROUND ART

In recent years, the demand for video distribution services has been increasing.

However, video traffic consumes a lot of bands. This makes reducing video traffic a critical issue for network operations.

Therefore, techniques to reduce video traffic have been proposed recently. For example, Patent Literature 1 discloses a technique for estimating a throughput of downloading videos and then selecting a bit rate at which the traffic volume becomes the lowest based on the estimated throughput.

Other techniques to reduce video traffic include traffic shaping. The traffic shaping is a band control technique that distributes videos at a constant bit rate (shaping rate).

### CITATION LIST

### Patent Literature

Patent Literature 1: Japanese Unexamined Patent Application Publication No. 2019-016961

### SUMMARY OF INVENTION

### Technical Problem

Incidentally, at the time of traffic shaping, there has been a demand from network operators to acquire the bit rate at which the shaping is done and in what resolution the video is being played on a terminal. That is, network operators have a demand to acquire the relationship between a video resolution and a bit rate.

However, the resolution of the video being played on a terminal fluctuates due to fluctuations in network quality. This means that in order to check the video resolution, the network operators have to actually watch the video on the terminal. The problem is that network operators need to collect a huge amount of data to acquire the relationship between the resolution of the video and bit rate, which can incur enormous costs.

An object of the present disclosure is to provide a video quality estimation apparatus, a video quality estimation method, and a video quality estimation system that can solve the above problem and enables acquisition of a relationship between a video resolution and a bit rate without incurring enormous costs.

### Solution to Problem

In an example aspect, a video quality estimation apparatus includes:
a first collection unit configured to collect network quality information about a network pertaining to distribution of a video;
a second collection unit configured to collect video quality information about the video; and
an estimation unit configured to estimate a first bit rate corresponding to a resolution of the video based on the network quality information and the video quality information.

In another example aspect, a video quality estimation method includes:
collecting network quality information about a network pertaining to distribution of a video;
collecting video quality information about the video; and
estimating a first bit rate corresponding to a resolution of the video based on the network quality information and the video quality information.

In another example aspect, a video quality estimation system includes:
a first collection unit configured to collect network quality information about a network pertaining to distribution of a video;
a second collection unit configured to collect video quality information about the video; and
an estimation unit configured to estimate a first bit rate corresponding to a resolution of the video based on the network quality information and the video quality information.

### Advantageous Effects of Invention

According to the above example aspects, it is possible to achieve an effect of providing a video quality estimation apparatus, a video quality estimation method, and a video quality estimation system that enables acquisition of a relationship between a video resolution and a bit rate without incurring enormous costs.

### BRIEF DESCRIPTION OF DRAWINGS

FIG. 1 shows an example of an ABR streaming method;

FIG. 2 shows an example of traffic shaping;

FIG. 3 shows an example of traffic shaping;

FIG. 4 shows an example of video quality information;

FIG. 5 shows an example of a resolution distribution when videos are actually shaped;

FIG. 6 shows an example of a resolution distribution estimated from the video quality information;

FIG. 7 is a diagram showing an example of an overview of an operation of a video quality estimation apparatus according to each example embodiment;

FIG. 8 shows an example of an expression used to estimate a bit rate corresponding to a resolution of a video in the video quality estimation apparatus according to each example embodiment;

FIG. 9 is a block diagram showing an example of a configuration of a video quality estimation apparatus according to a first example embodiment;

FIG. 10 shows an example of a resolution of a video being played on a terminal;

FIG. 11 shows an example of a resolution of a video requested from a video distribution server by the terminal;

FIG. 12 shows an example of effective areas and invalid areas in a resolution distribution;

FIG. 13 is a diagram showing an example of a network arrangement of the video quality estimation apparatus according to the first example embodiment;

FIG. 14 is a diagram showing an example of a network arrangement of the video quality estimation apparatus according to the first example embodiment;

FIG. 15 is a flowchart showing an example of a flow of an operation of the video quality estimation apparatus according to the first example embodiment;

FIG. 16 shows an example of a verification on an effect of the video quality estimation apparatus according to the first example embodiment;

FIG. 17 is a block diagram showing an example of a configuration of a video quality estimation apparatus according to a second example embodiment.

FIG. 18 is a diagram showing an example of an overview of an operation of a video quality estimation apparatus according to the second example embodiment;

FIG. 19 is a flowchart showing an example of a flow of an operation of the video quality estimation apparatus according to the second example embodiment;

FIG. 20 is a diagram showing an example of an overview of an operation of a video quality estimation apparatus according to a modified example of the second example embodiment;

FIG. 21 is a block diagram showing an example of a configuration of a video quality estimation apparatus that conceptually shows example embodiments;

FIG. 22 is a flowchart showing an example of a flow of the video quality estimation apparatus shown in FIG. 21;

FIG. 23 shows an example of a configuration of a video quality estimation system including the video quality estimation apparatus shown in FIG. 21; and

FIG. 24 is a block diagram showing an example of a hardware configuration of a computer for implementing the video quality estimation apparatus according to the example embodiments.

### EXAMPLE EMBODIMENT

Prior to describing example embodiments of the present disclosure, detailed descriptions of a problem to be solved by the present disclosure and an overview of an operation of each example embodiments of the present disclosure will be provided.

### Problem to Be Solved by The Present Disclosure

First, details of the problem to be solved by the present disclosure will be described.

ABR streaming methods such as ABR (Adaptive Bit Rate) Streaming Over HTTP (Hypertext Transfer Protocol) are currently the most popular video distribution methods.

The ABR streaming methods, which are standardized by MPEG-DASH (Moving Picture Experts Group - Dynamic Adaptive Streaming over HTTP) and other standards, aim to deliver videos at maximum quality that does not exceed available band of a network.

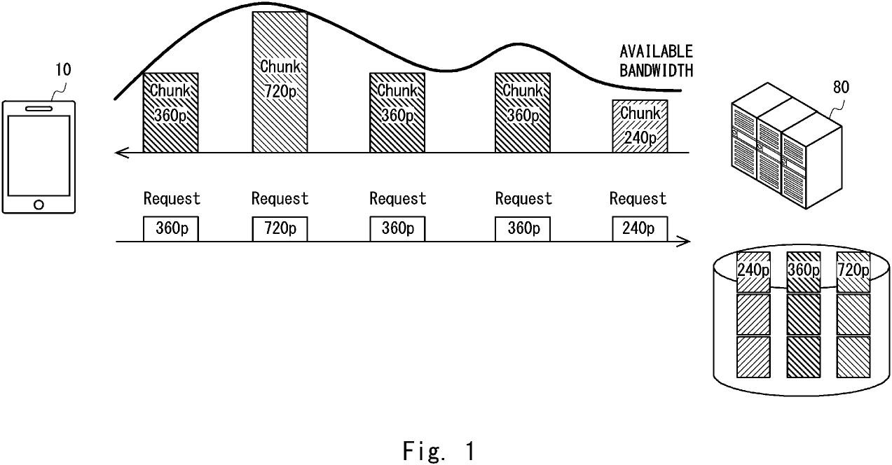

More specifically, in the ABR streaming methods, as shown in FIG. 1, a terminal 10 requests a video distribution server 80 for a video of maximum quality (where the quality is a resolution) that does not exceed the available band of the network. The video distribution server 80 holds a video of each quality and transmits the video of the quality requested by the terminal 10 to the terminal 10. In this case, the video is transmitted in units called chunks.

Here, in the ABR streaming methods, as described above, the resolution is adjusted to provide a video of stable quality within the available band of the network. Thus, the video quality can be controlled by traffic shaping.

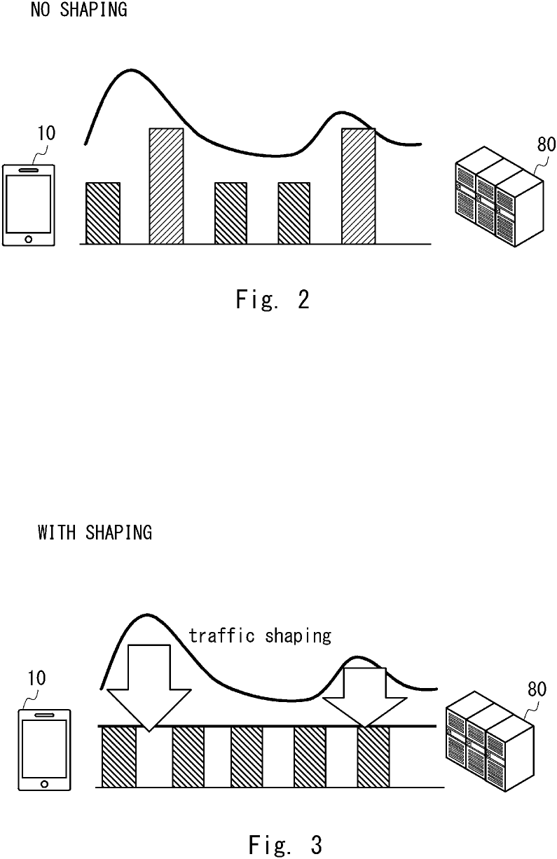

As shown in FIGS. 2 and 3, the traffic shaping is a band control technology that allows videos to be transmitted at a constant bit rate (shaping rate) and thus can control resolutions of the videos. The traffic shaping can be done anywhere on the network.

Here, when the traffic shaping is performed, there is a demand from a network operator to acquire what bit rate the shaping is performed and in what resolution the video is being played on the terminal 10. That is, the network operator has a demand to acquire the relationship between a video resolution and a bit rate.

If the network operator can acquire the relationship between a video resolution and a bit rate, he/she can, for example, determine an indicator of a shaping rate for providing a certain video having a certain resolution and provide a certain video having a high resolution according to the shaping rate. In addition, if the network operator can provide a certain video having a higher resolution, he/she can inform the user using the terminal 10 by saying, for example, “You can watch videos having a high resolution on this network!”.

However, the resolution of the video being played on the terminal 10 fluctuates due to fluctuations in network quality. This means that the network operator needs to actually watch the video to check the resolution of the video. The problem is that network operators need to collect a huge amount of data to know the relationship between video resolution and bit rate, which can incur enormous costs.

Each of the example embodiments of the present disclosure described below will contribute to solving the above problem to be solved.

### Overview of Operation of Example Embodiments of the Present Disclosure

Next, an overview of an operation of each example embodiment of the present disclosure is described.

A bit rate that corresponds to a video resolution can sometimes be obtained without actually watching the video.

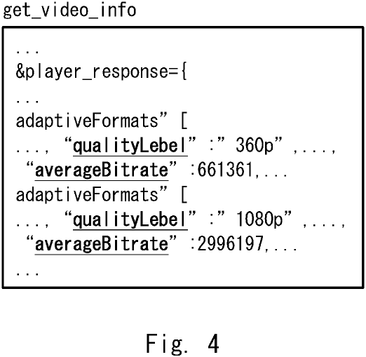

For example, video quality information about a certain video such as “get_video_info” shown in FIG. 4 can be obtained from YouTube (registered trademark).

According to “get_video_info” shown in FIG. 4, for a certain video, the resolution “1080P” and an average bit rate “661361” corresponding to the resolution “1080P” are listed together as a pair, and the resolution “360P” and an average bit rate “2996197” corresponding to the resolution “360P” are listed together as a pair.

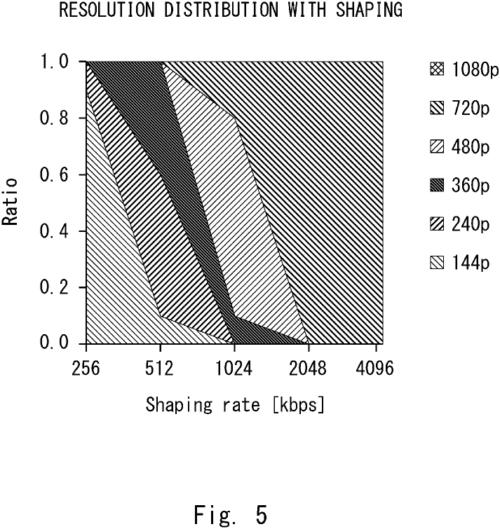

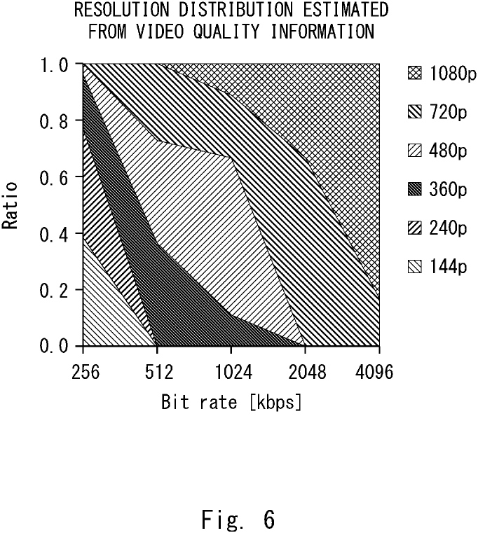

However, a resolution distribution estimated from the video quality information is different from a resolution distribution when the video is actually shaped. This point will be described with reference to FIGS. 5 and 6. The resolution distribution is a distribution indicating a ratio of each resolution corresponding to a bit rate.

FIG. 5 shows an example of the resolution distribution when a given 10 videos are actually shaped. In FIG. 5, the horizontal axis shows the shaping rate and the vertical axis shows the ratio of each resolution. Specifically, FIG. 5 shows that, for example, with a shaping rate of 256 [kbps], the terminal 10 plays about 90% of videos having a resolution of 144P and about 10% of videos having a resolution of 240 P.

On the other hand, FIG. 6 shows an example of the resolution distribution estimated from the video quality information about the video. In FIG. 6, the horizontal axis shows the bit rate (shaping rate) and the vertical axis shows the ratio in a manner similar to the vertical axis in FIG. 5.

Comparing FIG. 5 with FIG. 6, the resolution distribution estimated from the video quality information shown in FIG. 6 greatly differs from the resolution distribution during actual shaping shown in FIG. 5. It is assumed that the reason for this is that the actual resolution of the video being played on the terminal 10 fluctuates due to fluctuations in network quality.

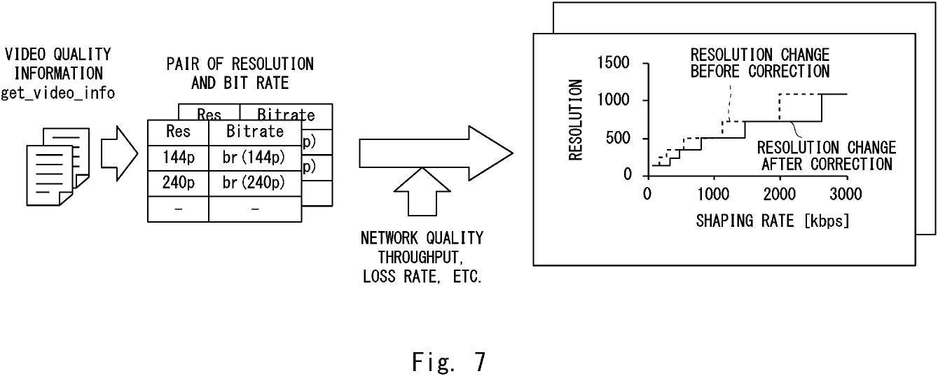

Therefore, in each example embodiment of the present disclosure, it is assumed that the bit rate corresponding to the video resolution is estimated by modifying the video quality information by using the network quality information (e.g., throughput, frame loss rate, etc.) as shown in FIG. 7.

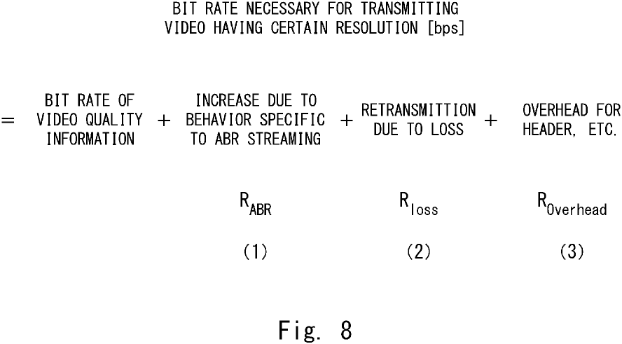

More specifically, in each example embodiment of the present disclosure, it is assumed that the bit rate required to transmit a video having a certain resolution [bps], as shown in FIG. 8, is the bit rate corresponding to that resolution obtained from the video quality information, plus the following bit rates.
(1) Incremental bit rate R_{ABR} [bps] due to a behavior specific to ABR streaming methods
(2) Bit rate Rₗₒₛₛ [bps] of retransmission due to loss
(3) Bit rate R_{overhead} [bps] of overhead such as headers

The bit rates (1) to (3) above will be described in detail in the following respective example embodiments of the present disclosure.

Hereinafter, the details of each example embodiment of present disclosure will be described. The following descriptions and drawings have been omitted and simplified as appropriate for clarity of explanation. In each of the drawings below, the same elements are assigned the same signs, and repeated descriptions are omitted as necessary.

### First Example Embodiment

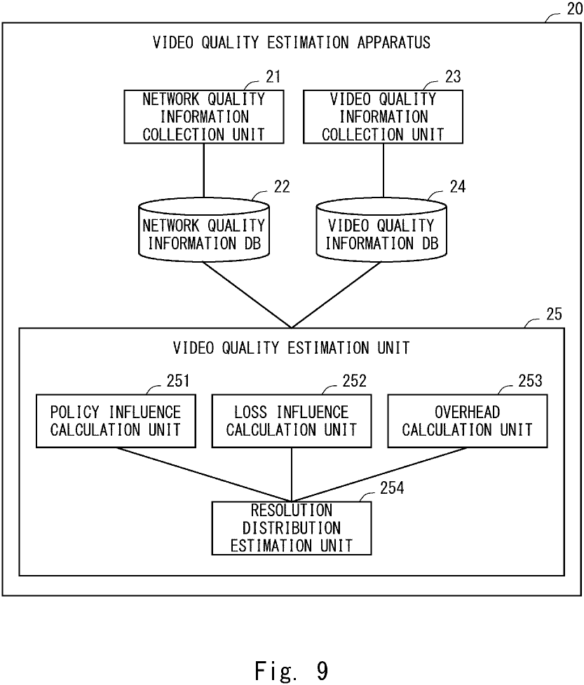

First, a configuration example of a video quality estimation apparatus 20 according to a first example embodiment will be described with reference to FIG. 9.

As shown in FIG. 9, the video quality estimation apparatus 20 according to the first example embodiment includes a network quality information collection unit 21, a network quality information DB (Data Base) 22, a video quality information collection unit 23, a video quality information DB 24, and a video quality estimation unit 25.

The network quality information collection unit 21 collects the network quality information about the network pertaining to distribution of a video. The network quality information includes a frame loss rate, an average throughput, and so on. For example, the network quality information collection unit 21 collects the network quality information set in advance from the network operator.

The network quality information DB 22 stores the network quality information collected by the network quality information collection unit 21.

When the terminal 10, which is a destination for video distribution, is a mobile terminal, the network pertaining to distribution of a video is composed of a radio network between the terminal 10 and a base station 30, which will be described later, a core network, the Internet 70, which will be described later, and a network on the side of the video distribution server 80. The core network may be an MNO (Mobile Network Operator) network 40 described later or the MNO network 40 and an MVNO (Mobile Virtual Network Operator) network 50 described later.

The video quality information collection unit 23 collects the video quality information about each of one or more videos. The video quality information includes a video resolution, a bit rate, and so on. For example, the video quality information collection unit 23 collects the video quality information set in advance from the video distribution server 80 and the network operator.

The video quality information DB 24 stores the video quality information collected by the video quality information collection unit 23.

Based on the network quality information stored in the network quality information DB 22 and the video quality information stored in the video quality information DB 24, the video quality estimation unit 25 estimates the bit rate corresponding to the resolution of the video. Furthermore, the video quality estimation unit 25 estimates a resolution distribution indicating the ratio of each resolution corresponding to the video bit rate.

Here, the video quality estimation unit 25 includes a policy influence calculation unit 251, a loss influence calculation unit 252, an overhead calculation unit 253, and a resolution distribution estimation unit 254.

The policy influence calculation unit 251 calculates (1) the incremental rate R_{ABR} [bps] due to a behavior specific to ABR streaming methods shown in FIG. 8.

The loss influence calculation unit 252 calculates (2) the bit rate Rₗₒₛₛ [bps] of retransmission due to loss as shown in FIG. 8.

The overhead calculation unit 253 calculates (3) the bit rate R_{overhead} [bps] of overhead such as headers shown in FIG. 8.

When the resolution distribution estimation unit 254 estimates a bit rate corresponding to the estimation target resolution of the estimation target video, it adds R_{ABR}, Rₗₒₛₛ, and R_{overhead} calculated by the policy influence calculation unit 251, the loss influence calculation unit 252, and the overhead calculation unit 253, respectively, to the bit rate corresponding to the estimation target resolution, which is included in the video quality information about the estimation target video, as shown in FIG. 8. Next, the resolution distribution estimation unit 254 estimates the bit rate after the above addition as the bit rate corresponding to the estimation target resolution of the estimation target video. The resolution distribution estimation unit 254 estimates a resolution distribution indicating the ratio of each resolution corresponding to the bit rate by performing this estimation for each resolution included in each piece of the video quality information about each video collected by the video quality information collection unit 23.

Hereinafter, operations of the policy influence calculation unit 251, the loss influence calculation unit 252, the overhead calculation unit 253, and the resolution distribution estimation unit 254 will be described in detail.

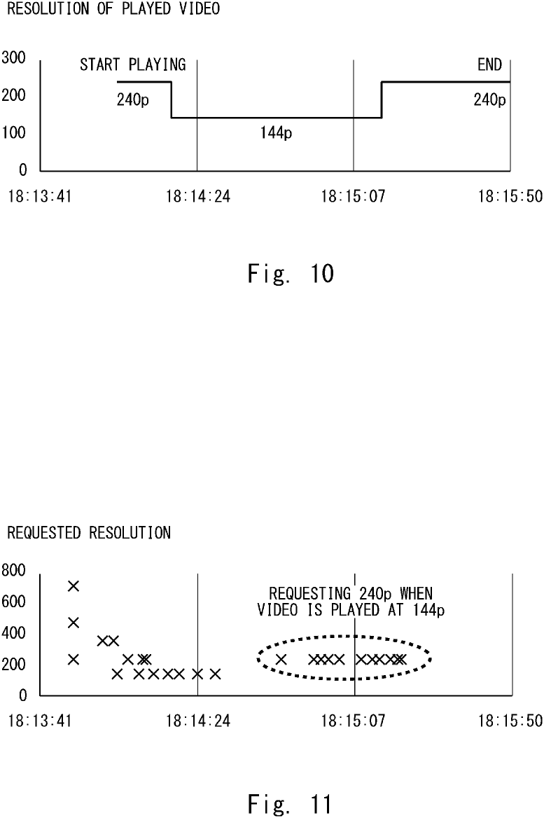

First, the operation of the policy influence calculation unit 251 will be described with reference to FIGS. 10 and 11.

As described with reference to FIG. 1, in the ABR streaming method, the terminal 10 requests a video (chunk) of a certain resolution from the video distribution server 80, and the video distribution server 80 transmits the video of the resolution requested by the terminal 10 to the terminal 10.

FIG. 10 shows an example of the resolution of the video being played on the terminal 10, and FIG. 11 shows an example of the resolution of the video being requested from the terminal 10 to the video distribution server 80. In FIGS. 10 and 11, the horizontal axis shows the time and the vertical axis shows the resolution.

As shown in FIGS. 10 and 11, when a video is being played having a low resolution of 144 p, the terminal 10 requests a video having a high resolution of 240p.

This suggests that if the resolution of the video being played is low, the terminal 10 tends to increase the resolution.

Therefore, when the policy influence calculation unit 251 estimates the bit rate corresponding to the estimation target resolution of the estimation target video, it determines the incremental rate R_{ABR} due to the behavior specific to the ABR streaming methods according to whether the estimation target resolution, which is included in the video quality information about the estimation target video, is greater than or equal to a standard resolution. In this case, the standard resolution may be, for example, stored in advance in the network quality information DB 22.

i) If the resolution is lower than the standard resolution

If the estimation target resolution is lower than the standard resolution, it is considered that the terminal 10 requests a higher resolution video in an attempt to increase the resolution to the standard resolution.

Therefore, the policy influence calculation unit 251 determines R_{ABR} as shown in the following Expression 1.

$${R}_{\text{ABR}} = {β}_{R + 1} \qquad \text{[Expression 1]}$$

Note that β_{R+1} may be a fixed value or a variable value that varies according to the size of the difference from the standard resolution.

ii) If the resolution is greater than or equal to the standard resolution

If the estimation target resolution is greater than or equal to the standard resolution, it is considered that the terminal 10 will continue to request a video in the current resolution, because there is no need to increase the resolution.

Therefore, the policy influence calculation unit 251 determines R_{ABR} as in the following Expression 2.

$${R}_{\text{ABR}} = 0 \qquad \text{[Expression 2]}$$

Next, the operation of the loss influence calculation unit 252 will be described.

When a frame loss occurs, video data for the number of losses × 1 frames is retransmitted.

Therefore, when the loss influence calculation unit 252 estimates the bit rate corresponding to the estimation target resolution of the estimation target video, it calculates the bit rate Rₗₒₛₛ for the retransmission due to a frame loss as an expected value of the bit rate of the video data for the retransmission.

The expected value E [β_{R}(ρ)] of the bit rate β_{R}(ρ) of the retransmitted video data can be calculated by using the frame loss rate ρ included in the network quality information as shown in Expression 3 below.

$$\begin{matrix}{R}_{\text{loss}} = \text{E} \left[{β}_{R} \left(ρ\right)\right] = {lim}_{n \to ∞} {\text{E}}_{\text{n}} \left[{β}_{R} \left(ρ\right)\right] = \\ {lim}_{n \to ∞} \left(\frac{ρ + {ρ}^{n}}{1 - ρ} ∗ {β}_{R} + {\sum }_{i = 1}^{n} {ρ}^{i} \left(i + 1\right) {β}_{R}\right) \\ = {β}_{R} \frac{1 + ρ - {ρ}^{2}}{{\left(1 - ρ\right)}^{2}}\end{matrix} \qquad \text{[Expression 3]}$$

Here, the probability of no frame loss is 1- (probability of no frame loss). Thus, the probability of no frame loss can be calculated by the following Expression 4.

$${p}_{\text{nloss}} = 1 - \left(ρ + {ρ}^{2} + ⋯ + {ρ}^{n}\right) = 1 - \frac{1 - {ρ}^{n}}{1 - ρ} = \frac{ρ + {ρ}^{n}}{1 - ρ} \qquad \text{[Expression 4]}$$

The first term in the limit function of Expression 3 indicates the bit rate when no frame loss occurs, and the second term indicates the bit rate when n frame losses occur.

Proceeding with the calculation in Expression 3, the following Expression 5 is obtained.

$$\begin{matrix}{E}_{n} \left[β \left(ρ\right)\right] = \\ \frac{\left(1 + n\right) {β}_{R} {ρ}^{n + 2} - \left(2 + n\right) {β}_{R} {ρ}^{n + 1} + {β}_{R} {ρ}^{n} - {β}_{R} {ρ}^{n - 1} - {β}_{R} {ρ}^{2} + {β}_{R} ρ + {β}_{R}}{{\left(1 - ρ\right)}^{2}}\end{matrix} \qquad \text{[Expression 5]}$$

Here, the n raised to the power of n is faster than n multiplied. Thus, when a limit is taken from n→∞₎, the power of n is dominant. Therefore, Expression 3 gives the above result.

Next, the operation of the overhead calculation unit 253 will be described.

When the overhead calculation unit 253 transmits a video, it transmits video data with a header attached.

Thus, when the overhead calculation unit 253 estimates a bit rate of a video, the bit rate required to transmit the header must also be taken into account as an overhead. Also, the bit rate required to transmit the header varies depending on the header size.

Here, the video data is fragmented into the size of the Maximum Transmission Unit (MTU) and then transmitted.

Therefore, when the overhead calculation unit 253 estimates the bit rate corresponding to the estimation target resolution of the estimation target video, it can calculate the bit rate R_{overhead} for the overhead by the header by using Expression 6 below. In this expression, η is an expected value of the header size, and β is the bit rate. Note that β is the bit rate corresponding to the estimation target resolution, which is included in the video quality information about the estimation target video.

$${R}_{\text{Overhead}} = β ∗ \frac{η}{M T U} \qquad \text{[Expression 6]}$$

Here, the calculation of the expected value η of the header size requires individual packets making up the frame. Therefore, as the expected value η of the header size, the maximum value is considered taking the processing load into account.

For example, if the packets making up the frame are Transmission Control Protocol (TCP)/HTTP packets, the expected header size, η, is obtained by Expression 7 below.

$$η = {η}_{\text{MAC}} + {η}_{1 \text{P}} + {η}_{\text{TCP}} \qquad \text{[Expression 7]}$$

If the packets making up the frame are User Datagram Protocol (UDP)/Quick UDP Internet Connections (QUIC)/HTTP packets, the expected header size, η, is expressed by the following Expression 8.

$$η = {η}_{\text{MAC}} + {η}_{1 \text{P}} + {η}_{\text{UDP}} + {η}_{\text{QUIC}} \qquad \text{[Expression 8]}$$

Next, the operation of the resolution distribution estimation unit 254 will be described.

When the resolution distribution estimation unit 254 estimates the bit rate corresponding to the estimation target resolution of the estimation target video, it adds R_{ABR}, Rₗₒₛₛ, and R_{overhead} calculated by the policy influence calculation unit 251, the loss influence calculation unit 252, and the overhead calculation unit 253, respectively, to the bit rate corresponding to the estimation target resolution, which is included in the video quality information about the estimation target video, as shown in FIG. 8. Next, the resolution distribution estimation unit 254 estimates the bit rate after the addition as the bit rate corresponding to the estimation target resolution of the estimation target video.

Therefore, when the estimation target video is played in the estimation target resolution on the terminal 10, the bit rate estimated to correspond to the estimation target resolution of the estimation target video is used as the shaping rate to shape the estimation target video.

However, shaping at a shaping rate greater than the average throughput of the network does not change the quality of the video played on the terminal 10 compared to shaping at a shaping rate equal to the average throughput.

Thus, the resolution distribution estimation unit 254 adjusts the bit rate estimated to correspond to the resolution of the estimation target resolution based on the average throughput of the network.

Specifically, the resolution distribution estimation unit 254 adjusts the estimated bit rate to the value of the average throughput if the estimated bit rate is higher than the average throughput, and otherwise leaves the estimated bit rate unchanged.

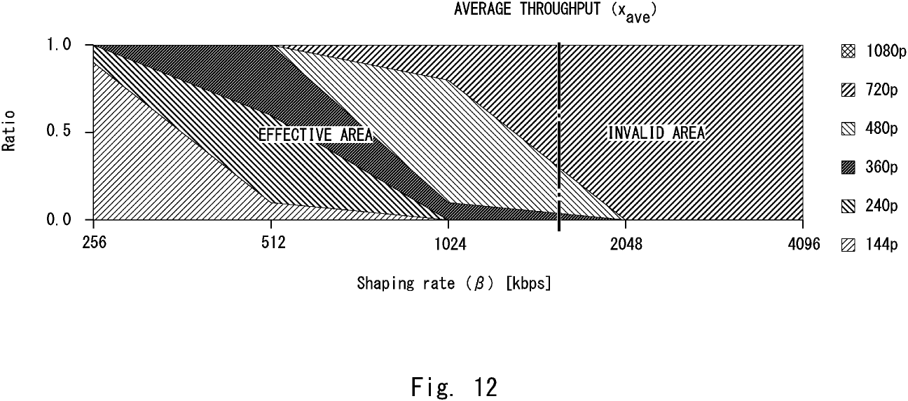

In this case, the range of the distribution of the shaping rate β would be adjusted, as shown in FIG. 12. In the example of FIG. 12, only areas where the shaping rate β is less than or equal to the average throughput xₐᵥₑ become effective areas, and areas where the shaping rate β is higher than the average throughput xₐᵥₑ become invalid areas.

If the range of the distribution of the shaping rate β is adjusted, as shown in FIG. 12, the resolution of the video played on the terminal 10 will be adjusted, as shown in Expression 9 below. That is, when the shaping rate β is greater than the average throughput xₐᵥₑ, the resolution of the video to be played on the terminal 10 is the resolution corresponding to the average throughput xₐᵥₑ, and otherwise is the resolution corresponding to the shaping rate β.

$$R e s o l u t i o n \left(β\right) = \left\{\begin{matrix}R e s o l u t i o n \left({x}_{\text{ave}}\right) β > {x}_{a v e} \\ R e s o l u t i o n \left(β\right) \text{otherwise}\end{matrix}\right) \qquad \text{[Expression 9]}$$

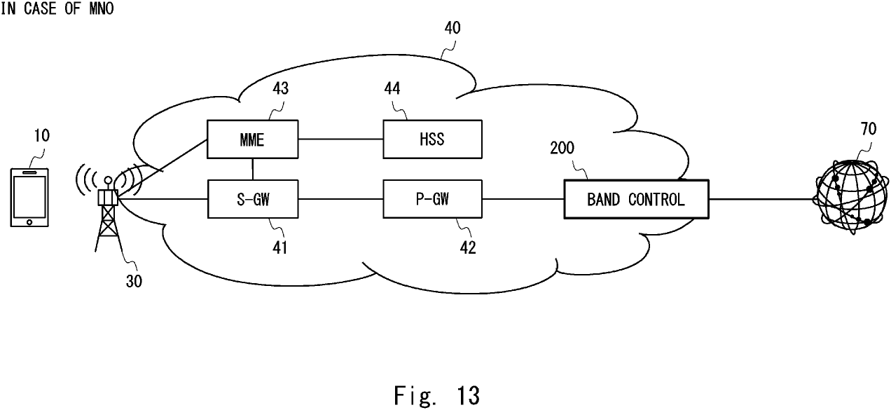

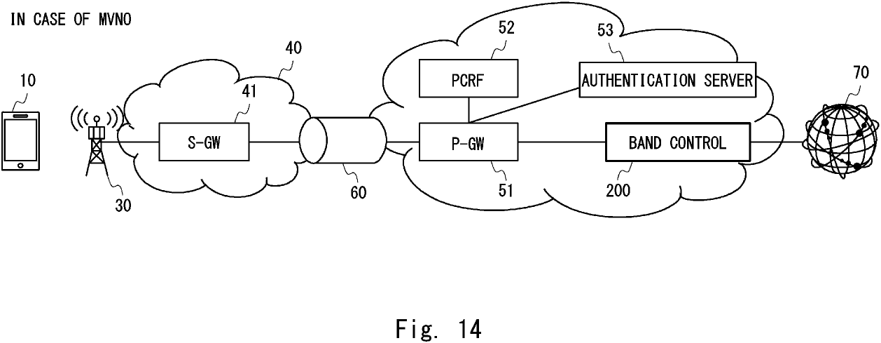

Next, an example of a network arrangement of the video quality estimation apparatus 20 according to the first example embodiment will be described with reference to FIGS. 13 and 14. In FIGS. 13 and 14, the video distribution server 80 is provided farther from the terminal 10 than the Internet 70 when viewed from the terminal 10, although it is not shown in the drawing.

The video quality estimation apparatus 20 according to the first example embodiment is disposed inside a band control apparatus 200 for performing band control of videos by, for example, shaping the videos.

In the example of FIG. 13, the band control apparatus 200 is disposed in the MNO network 40. The MNO network 40 is connected to the base station 30 and the Internet 70. In the MNO network 40, in addition to the band control apparatus 200, a Serving Gateway (S-GW) 41, a P-GW (Packet Data Network Gateway) 42, a Mobility Management Entity (MME) 43, and a Home Subscriber Server (HSS) 44 are disposed.

In the example of FIG. 14, the band control apparatus 200 is disposed in the MVNO network 50. The MVNO network 50 is connected to the MNO network 40 through a network tunnel 60 and is also connected to the Internet 70. In the MVNO network 50, in addition to the band control apparatus 200, a P-GW 51, a Policy and Charging Rules Function (PCRF) 52 and the authentication server 53 are disposed. The MNO network 40 is connected to the base station 30, where the S-GW 41 is disposed.

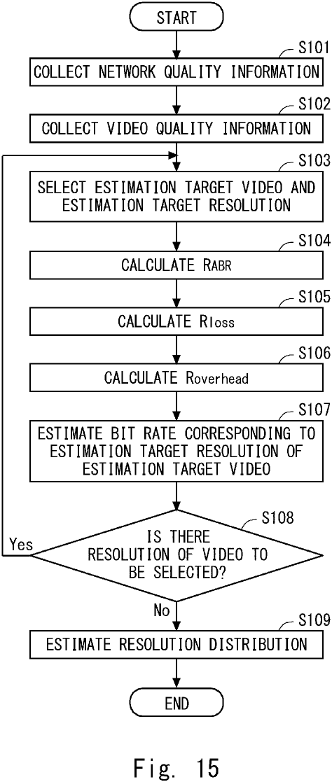

Next, an example of the operation flow of the video quality estimation apparatus 20 according to the first example embodiment will be described with reference to FIG. 15.

As shown in FIG. 15, first, the network quality information collection unit 21 collects the network quality information about the network pertaining to the distribution of the video (Step S101). The collected network quality information is stored in the network quality information DB 22.

Next, the video quality information collection unit 23 collects the video quality information about each of one or more videos (Step S102). The collected video quality information is stored in the video quality information DB 24.

Note that Steps S101 and S102 are not limited to be performed in this order, but may be performed in reverse order or simultaneously.

Next, the video quality estimation unit 25 selects any one of the one or more videos whose video quality information has been collected by the video quality information collection unit 23 as an estimation target video, and selects any one of the one or more resolutions included in the video quality information about the selected estimation target video as an estimation target (Step S103).

Next, in the video quality estimation unit 25, with regard to the estimation target resolution of the estimation target video, based on the network quality information and the video quality information about the estimation target video, the policy influence calculation unit 251 calculates (1) the incremental rate R_{ABR} due to the behavior specific to the ABR streaming methods (Step S104), the loss influence calculation unit 252 calculates (2) the bit rate Rₗₒₛₛ for retransmission due to loss (Step S105), and the overhead calculation unit 253 calculates (3) the bit rate R_{overhead} of overhead such as headers (Step S106).

Steps S104 to S106 are not limited to be performed in this order, but may be performed in any order or simultaneously.

Next, in the video quality estimation unit 25, the resolution distribution estimation unit 254 adds the R_{ABR}, Rₗₒₛₛ, and R_{overhead} calculated in Steps S104 to S106, respectively, to the bit rate corresponding to the resolution of the estimation target included in the video quality information about the estimation target video. Next, the resolution distribution estimation unit 254 estimates the bit rate after the addition as the bit rate corresponding to the estimation target resolution of the estimation target video (Step S107). At this time, the resolution distribution estimation unit 254 may adjust the estimated bit rate based on the average throughput of the network.

Next, the video quality estimation unit 25 determines whether or not the video quality information collected by the video quality information collection unit 23 still includes a video and a resolution to be selected as the estimation target (Step S108). For example, if a condition stipulates that all or a predetermined number of video resolutions included in the video quality information should be subject to estimation and if the condition has not yet been satisfied, the determination in Step S108 is Yes.

If there is still a video and a resolution to be selected as the estimation target in Step S108 (Yes in Step S108), the video quality estimation unit 25 returns to the processing in Step S103, selects one video as the estimation target, selects one resolution of the selected video as the estimation target, and then performs the processing in Steps S104 to S107.

On the other hand, if there is no remaining video and resolution to be selected as the estimation target in Step S108 (No in Step S108), in the video quality estimation unit 25, the resolution distribution estimation unit 254 estimates a resolution distribution indicating a ratio of each resolution corresponding to the bit rate based on the estimated result of the bit rate estimated to correspond to the estimation target resolution of the estimation target video (Step S109).

As described above, according to the first example embodiment, the network quality information collection unit 21 collects the network quality information about the network pertaining to the distribution of the video. The video quality information collection unit 23 collects the video quality information about the videos. The video quality estimation unit 25 estimates the bit rate corresponding to the resolution of the video based on the network quality information and the video quality information.

Specifically, when the video quality estimation unit 25 estimates the bit rate corresponding to the estimation target resolution of the estimation target video, it adds the following bit rates (1) to (3) to the bit rate corresponding to the estimation target resolution, which is included in the video quality information about the estimation target video, and estimates the added bit rate as the bit rate corresponding to the estimation target resolution of the estimation target video.
(1) Incremental bit rate R_{ABR} due to a behavior specific to ABR streaming methods
(2) Bit rate Rₗₒₛₛ of retransmission due to loss
(3) Bit rate R_{overhead} of overhead such as headers

This allows the network operator to acquire the bit rate that corresponds to the video resolution without having to actually watch the video and collect a huge amount of data. It is therefore possible to acquire the relationship between a video resolution and bit rate without incurring enormous costs.

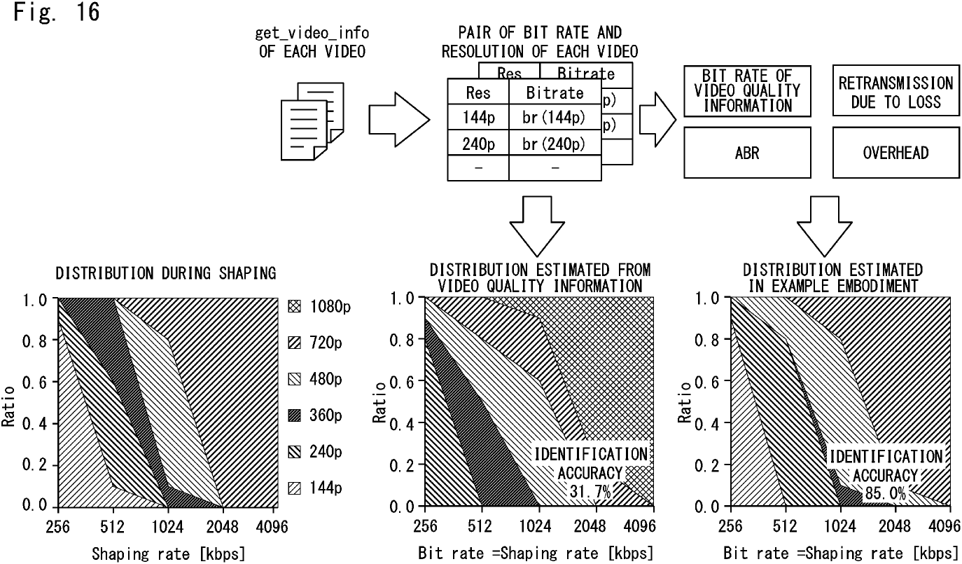

The effect of the first example embodiment is verified with reference to FIG. 16.

The lower left diagram of FIG. 16 shows an example of the resolution distribution of 10 videos when they are actually shaped. The middle lower diagram of FIG. 16 show an example of the resolution distribution estimated from the video quality information alone. The lower right diagram of FIG. 16 shows an example of the resolution distribution estimated from the video quality information, the behavior specific to the ABR streaming methods, the amount of retransmission due to loss, and the overhead such as headers in the first example embodiment. The horizontal and vertical axes in the lower left diagram of FIG. 16 are the same as those in FIG. 5, and the horizontal and vertical axes in the middle lower diagram and right lower diagram of FIG. 16 are the same as those in FIG. 6.

Here, in the middle lower diagram and right lower diagram of FIG. 16, it is determined whether or not the estimated resolution corresponding to each shaping rate is correct (whether or not the estimated resolution corresponding to each shaping rate matches the resolution in the lower left diagram of FIG. 16), and a value of 1 is given if it is correct, and a value of 0 is given if it is incorrect, and the average value of each shaping rate is used as an identification accuracy.

As shown in the middle lower diagram of FIG. 16, the resolution distribution estimated from the video quality information alone has a low identification accuracy of 31.7 [%], which is largely different from the resolution distribution in the lower left diagram of FIG. 16.

On the other hand, as shown in the lower right diagram of FIG. 16, the resolution distribution estimated from the video quality information, the behavior specific to the ABR streaming methods, the amount of retransmission due to loss, and overhead such as headers in the first example embodiment has a high identification accuracy of 86.0 [%], which is very close to the resolution distribution in the lower left diagram of FIG. 16.

Thus, it can be seen that according to the first example embodiment, it is possible to estimate the relationship between a video resolution and a bit rate, i.e., the resolution distribution indicating the ratio of each resolution corresponding to the bit rate, while taking fluctuations in network quality into account.

This makes it possible to estimate the resolution distribution for certain network quality. For example, the resolution distribution can be estimated when the network quality has an average throughput of 3 [Mbps] and a frame loss rate of 0.1 [%].

In addition, if the network operator can confirm that the video can be provided having a high resolution by referring to the resolution distribution according to the first example embodiment, he/she can inform the user using the terminal 10 by saying, for example, “You can watch videos having a high resolution on this network!”.

Moreover, the network operator will be able to use the resolution distribution according to the first example embodiment as a guide to avoid excessive shaping.

If the resolution distribution according to the first example embodiment is not present, an event such as shaping at a uniform shaping rate of 300 [kbps] occurs.

On the other hand, if the resolution distribution according to the first example embodiment is present, the resolution distribution enables the network operator to know the degree of the shaping rate at which 90% or more of videos can be provided with a resolution of 360 p or higher.

### Second Example Embodiment

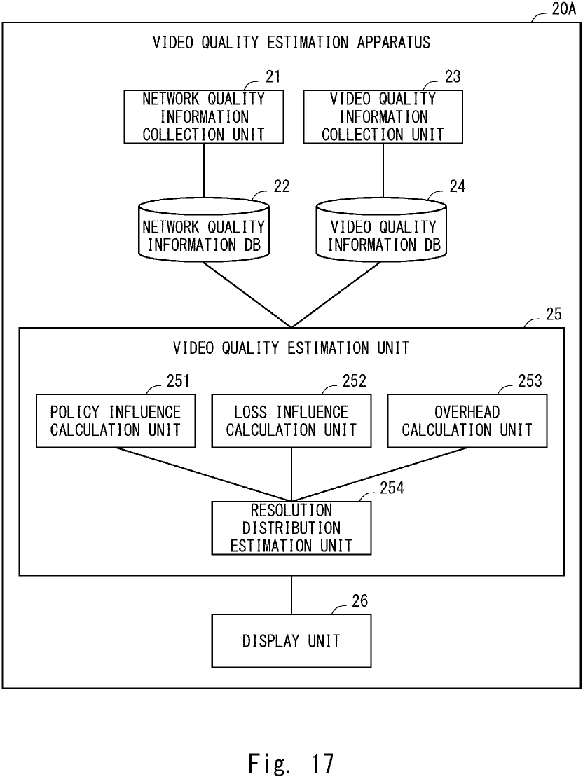

First, a configuration example of a video quality estimation apparatus 20A according to a second example embodiment will be described with reference to FIG. 17.

As shown in FIG. 17, a configuration of the video quality estimation apparatus 20A according to the second example embodiment differs from the configuration of the video quality estimation apparatus 20 in FIG. 9 according to the first example embodiment described above in that the video quality estimation apparatus 20A according to the second example embodiment includes a display unit 26.

The display unit 26 displays video quality such as the resolution distribution estimated by the video quality estimation unit 25 on a screen of the video quality estimation apparatus 20A.

The video quality estimation apparatus 20A according to the second example embodiment is also different from the video quality estimation apparatus 20 according to the first example embodiment described above in that the video quality estimation apparatus 20A according to the second example embodiment assumes that there are a plurality of base stations 30 and estimates the resolution distribution for each of a plurality of areas (cells) of the plurality of base stations 30.

Therefore, the network quality information collection unit 21 collects network quality information for each of the plurality of areas. The video quality estimation unit 25 estimates the resolution distribution for each of the plurality of areas.

An overview of an operation of the video quality estimation apparatus 20A according to the second example embodiment is described below with reference to FIG. 18.

As shown in FIG. 18, this example assumes that three base stations 30-1 to 30-3 are connected to the MNO network 40.

For each of the three areas 1 to 3 of the respective three base stations 30-1 to 30-3, the network quality information collection unit 21 collects the network quality information including a frame loss rate, an average throughput, and so on of the network in that area. Note that the networks of the three areas 1 to 3 have the same network configuration as that of the MNO network 40 and the network farther from the three base stations 30-1 to 30-3 than the MNO network 40.

In the video quality estimation unit 25, the policy influence calculation unit 251 calculates R_{ABR}, the loss influence calculation unit 252 calculates Rₗₒₛₛ, and the overhead calculation unit 253 calculates R_{overhead} for each of the three areas 1 to 3. Next, the resolution distribution estimation unit 254 estimates the resolution distribution for each of the three areas 1 to 3. Note that the method of estimating the resolution distribution itself is the same as that according to the first example embodiment described above, and thus a description thereof is omitted.

Furthermore, the resolution distribution estimation unit 254 estimates the average resolution for each of the three areas 1 to 3 based on the average throughput and the resolution distribution. For example, in the resolution distribution, the resolution distribution estimation unit 254 estimates, as the average resolution, the resolution with the highest ratio when the bit rate corresponds to the average throughput. Specifically, it is assumed that the estimated resolution distribution for an area is the resolution distribution shown in the lower right diagram of FIG. 16, and that the average throughput for that area is 512 [kbps]. Under this assumption, the resolution with the highest ratio is 240p at a bit rate of 512 kbps corresponding to the average throughput in the resolution distribution at the lower right diagram of FIG. 16. Therefore, the resolution distribution estimation unit 254 estimates the average resolution of the area to be 240 p.

Next, the display unit 26 displays each of the three areas 1 to 3 on a map and further displays the average resolution of each of the three areas 1 to 3 on the screen of the video quality estimation apparatus 20A.

Note that a display example by the display unit 26 in FIG. 18 is only an example and is not limited to this. For example, in the display example of FIG. 18, the average resolution is displayed as the video quality, but other indicators may be displayed. For example, the average resolution may be displayed in different colors, or the network quality information such as the table shown in FIG. 18 may be displayed in detail in response to a click on a part where the average resolution is displayed. The resolution distribution shown in FIG. 6 may also be displayed.

In the display example of FIG. 18, the display unit 26 displays the video quality on the screen of the video quality estimation apparatus 20A, but the present disclosure is not limited to this. The display unit 26 may display the video quality on any display apparatus (e.g., a display apparatus of the network operator, or the like) other than the video quality estimation apparatus 20A.

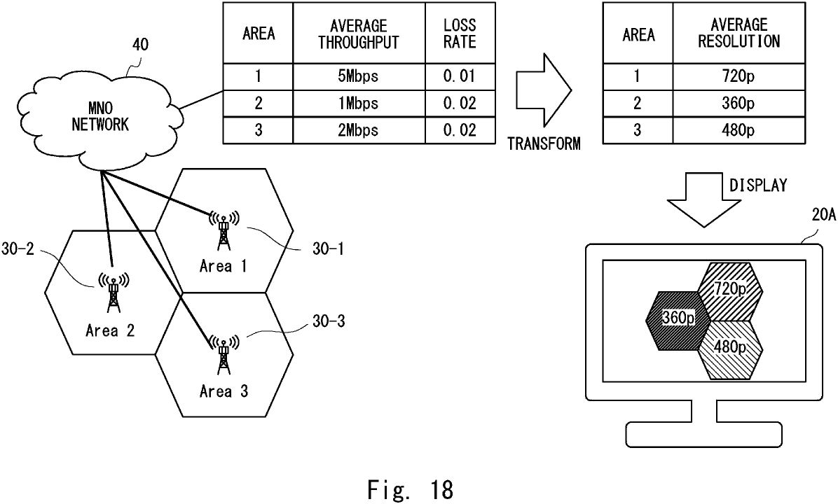

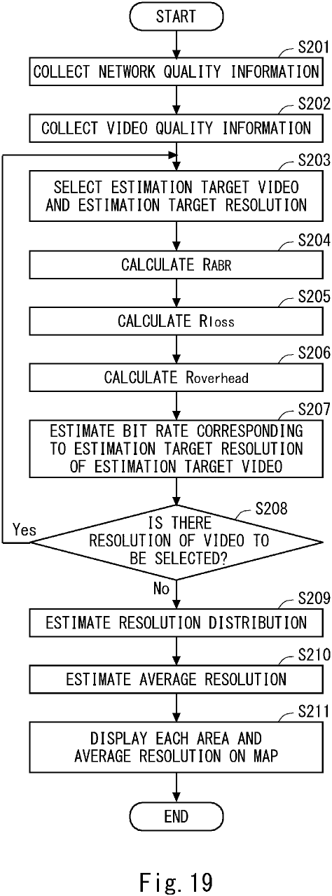

Next, an example of the operation flow of the video quality estimation apparatus 20A according to the second example embodiment will be described with reference to FIG. 19. Here, it is assumed that three base stations 30-1 to 30-3 are connected to the MNO network 40 as shown in FIG. 18.

As shown in FIG. 19, for the three areas 1 to 3 of the respective three base stations 30-1 to 30-3, the processing in Steps S201 to S209 similar to Steps S101 to S109 in FIG. 16 according to the first example embodiment described above is performed. Thus, the resolution distribution is estimated for each of the three areas 1 to 3.

Next, the resolution distribution estimation unit 254 estimates the average resolution for each of the three areas 1 to 3 based on the average throughput and the resolution distribution (Step S210).

After that, the display unit 26 displays each of the three areas 1 to 3 on the map and further displays the average resolution of each of the three areas 1 to 3 (Step S211).

As described above, according to the second example embodiment, the video quality estimation unit 25 estimates the resolution distribution for each of the plurality of areas and further estimates the average resolution. The display unit 26 displays each of the plurality of areas on a map and further displays the average resolution of each of the plurality of areas.

This allows a user to know at what level of resolution the video can be delivered in each of the plurality of areas.

Other effects are similar to those of the aforementioned first example embodiment.

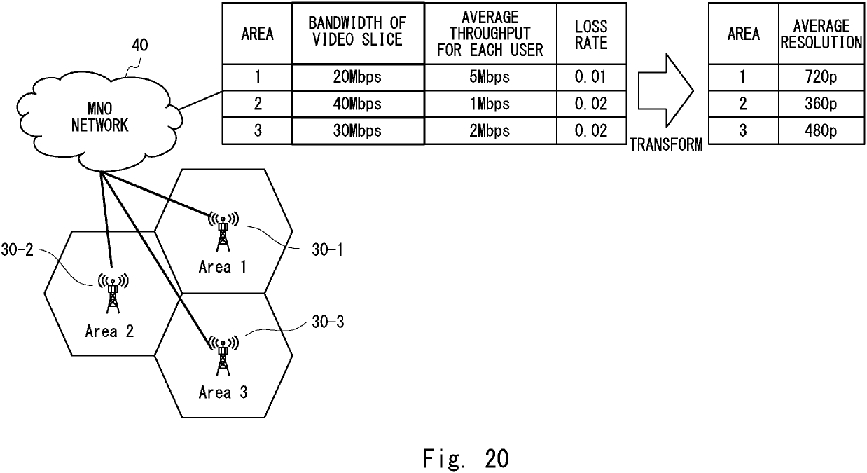

Here, a modified example according to the second example embodiment will be described with reference to FIG. 20.

As shown in FIG. 20, in this modified example, as in the example in FIG. 18, it is assumed that three base stations 30-1 to 30-3 are connected to the MNO network 40. It is also assumed that a band of a network slice is allocated to each of the three areas 1 to 3 of the respective three base stations 30-1 to 30-3 by using network slicing technology.

The resolution distribution estimation unit 254 estimates the average resolution for each of the three areas 1 to 3.

At this time, in an area where the number of camping terminals 10 is large, there is a possibility that the allocated band of the network slice may become insufficient and the average resolution may become lower than a target resolution.

Therefore, when there is an area in which the average resolution is lower than the target resolution, the resolution distribution estimation unit 254 may increase the band of the network slice allocated to that area. In this case, the resolution distribution estimation unit 254 may inform the component responsible for allocating the band of the network slice to each area to increase the band of the network slice allocated to a certain area.

It is preferable that the target resolution be common in a plurality of areas, and instead it may be different in each of the plurality of areas. The target resolution may be stored in advance in, for example, the network quality information DB 22.

### Other Example Embodiments

In the aforementioned first and second example embodiments, the components according to the present disclosure are arranged in one apparatus (in each of the video quality estimation apparatuses 20 and 20A), but the present disclosure is not limited to this. The components of the video quality estimation apparatuses 20 and 20A may be distributed over the network.

In the first and second example embodiments described above, the bit rate corresponding to the estimation target resolution is estimated by adding the following bit rates (1) to (3) to the bit rate corresponding to the estimation target resolution, which is included in the video quality information about the estimation target video, but the present disclosure is not limited to this.
(1) Incremental bit rate R_{ABR} [bps] due to a behavior specific to ABR streaming methods
(2) Bit rate Rₗₒₛₛ [bps] of retransmission due to loss
(3) Bit rate R_{overhead} [bps] of overhead such as headers

Even if only any one or two of the bit rates from (1) to (3) above are added, the estimated resolution distribution is considered to be close to the resolution distribution when videos are actually shaped. Therefore, any one or two bit rates from (1) to (3) above may be selected and only the selected bit rate(s) may be added. In this case, an amount of calculation can be reduced as compared to that when all the bit rates from (1) to (3) above are added.

### Concept of Example Embodiment

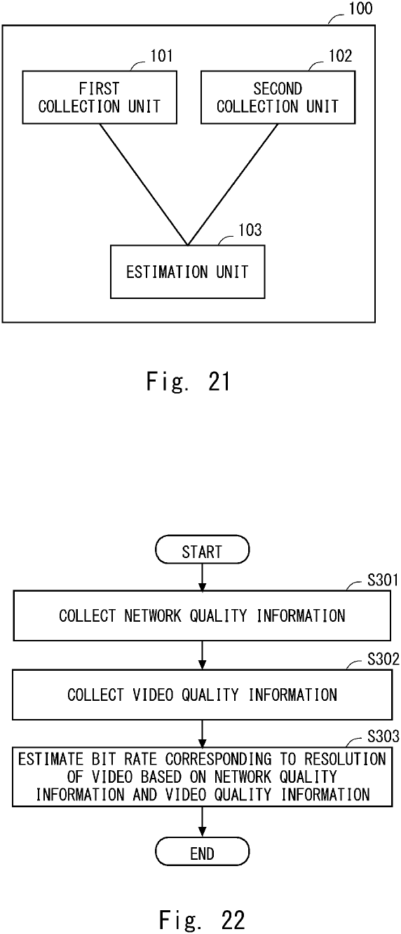

Next, a configuration example of a video quality estimation apparatus 100 conceptually showing the video quality estimation apparatuses 20 and 20A according to the aforementioned first and second example embodiments will be described with reference to FIG. 21.

The video quality estimation apparatus 100 shown in FIG. 21 includes a first collection unit 101, a second collection unit 102, and an estimation unit 103.

The first collection unit 101 corresponds to the network quality information collection unit 21 according to the aforementioned first and second example embodiments. The first collection unit 101 collects the network quality information about the network pertaining to the distribution of the video. The network quality information includes, for example, a frame loss rate, an average throughput, and so on of a network.

The second collection unit 102 corresponds to the video quality information collection unit 23 according to the aforementioned first and second example embodiments. The second collection unit 102 collects the video quality information about each of one or more videos. The video quality information includes, for example, the resolution of the video, a second bit rate of the video corresponding to the resolution, and so on.

The estimation unit 103 corresponds to the video quality estimation unit 25 according to the aforementioned first and second example embodiments. The estimation unit 103 estimates a first bit rate corresponding to the resolution of the video based on the network quality information and the video quality information.

At this time, the estimation unit 103 may specify a value to be added to the second bit rate corresponding to the resolution of the video included in the video quality information based on the network quality information and the video quality information, and estimate the first bit rate corresponding to the resolution of the video. More specifically, the estimation unit 103 may add a value to be added specified above to the second bit rate corresponding to the resolution of the video contained in the video quality information, and estimate the bit rate after the addition as the first bit rate corresponding to the resolution of the video.

If the resolution of the video included in the video quality information is lower than the standard resolution, the estimation unit 103 may add a predetermined bit rate to the second bit rate corresponding to the resolution of the video included in the video quality information as a value to be added.

The estimation unit 103 may also calculate the bit rate required for retransmitting the video data due to the frame loss based on the frame loss rate. Next, the estimation unit 103 may add the bit rate required for retransmitting the video data as a value to be added to the second bit rate corresponding to the resolution of the video included in the video quality information.

The estimation unit 103 may also calculate the bit rate required for transmitting the header based on the size of the header of the packet of the video data. Then, the estimation unit 103 may add the bit rate required for transmitting the header as a value to be added to the second bit rate corresponding to the resolution of the video included in the video quality information.

If the first bit rate estimated to correspond to the resolution of the video is higher than the average throughput, the estimation unit 103 may adjust the first bit rate to the value of the average throughput.

The estimation unit 103 may also estimate the first bit rate corresponding to one or more resolutions of one or more videos, and estimate a resolution distribution indicating a ratio of each resolution corresponding to the first bit rate based on the estimation result.

The video quality estimation apparatus 100 may further include a display unit. This display unit corresponds to the display unit 26 according to the second example embodiment described above. The estimation unit 103 may also estimate the resolution distribution for each of the plurality of areas and estimate the average resolution based on the estimated resolution distribution and the average throughput. The display unit may display each of the plurality of areas on the map and display the average resolution of each of the plurality of areas. Alternatively, the display unit may display the first bit rate corresponding to the resolution of the video estimated by the estimation unit 103.

In addition, the band of the network slice may be allocated to each of the plurality of areas. If there is an area with an estimated average resolution lower than the target resolution among the plurality of areas, the estimation unit 103 may increase the band of the network slice allocated to that area.

Next, an example of an operation flow of the video quality estimation apparatus 100 shown in FIG. 21 will be described with reference to FIG. 22.

As shown in FIG. 22, first, the first collection unit 101 collects the network quality information about the network pertaining to the distribution of the video (Step S301).

Next, the second collection unit 102 collects the video quality information about the video (Step S302).

Steps S301 to S302 are not limited to be performed in this order, but may be performed in any order or simultaneously.

After that, the estimation unit 103 estimates the bit rate corresponding to the resolution of the video based on the network quality information collected in Step S301 and the video quality information collected in Step S302 (Step S303).

As described above, according to the video quality estimation apparatus 100 shown in FIG. 21, the first collection unit 101 collects the network quality information about the network pertaining to the distribution of the video. The second collection unit 102 collects the video quality information about the video. The estimation unit 103 estimates a bit rate corresponding to the resolution of the video based on the network quality information and the video quality information.

This allows network operators to acquire the bit rate that corresponds to the video resolution without having to actually watch the video and collect a huge amount of data. It is therefore possible to acquire the relationship between a video resolution and bit rate without incurring enormous costs.

Next, a configuration example of a video quality estimation system including the video quality estimation apparatus 100 shown in FIG. 21 will be described with reference to FIG. 23.

The video quality estimation system shown in FIG. 23 includes a terminal 10, a network 110, and a video quality estimation apparatus 100.

The terminal 10 and the video quality estimation apparatus 100 are connected to the network 110.

The video distribution server 80 on the network 110 distributes videos to the terminal 10.

When the terminal 10 is a mobile terminal, the network 110 is a network composed of a radio network between the terminal 10 and the base station 30, a core network, the Internet 70, and a network on the side of the video distribution server 80. The core network may be MNO network 40 or MNO network 40 and MVNO network 50.

### Hardware Configuration of Video Quality Estimation Apparatus and Video Quality Estimation System According to Example Embodiments

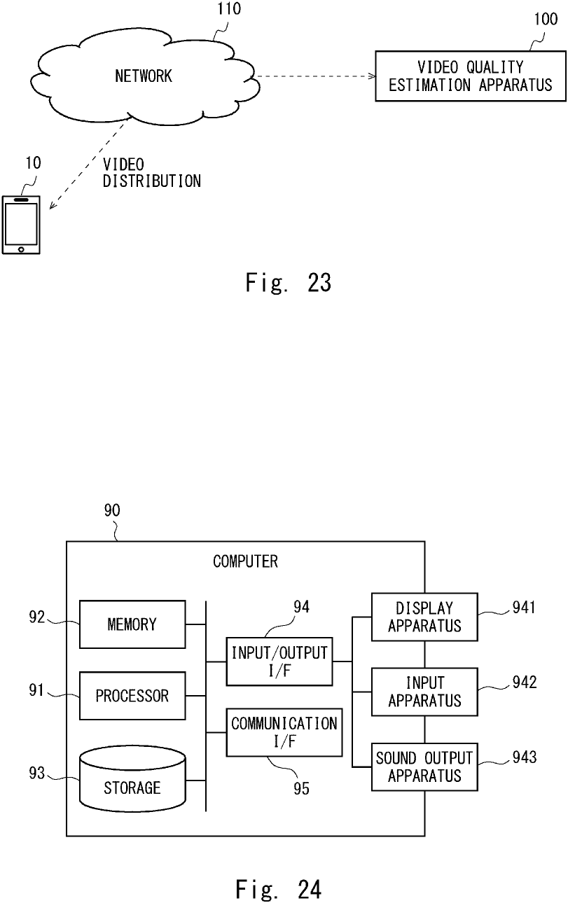

Next, a hardware configuration of a computer 90 for implementing the video quality estimation apparatuses 20 and 20A according to the aforementioned first and second example embodiments and the video quality estimation apparatus 100 relating to the concept of the above example embodiments will be described with reference to FIG. 24.

As shown in FIG. 24, the computer 90 includes a processor 91, a memory 92, a storage 93, an input/output interface (input/output I/F) 94, a communication interface (communication I/F) 95, etc. The processor 91, the memory 92, the storage 93, the input/output interface 94, and the communication interface 95 are connected by a data transmission path for transmitting and receiving data to each other.

The processor 91 is, for example, an arithmetic processing unit such as a CPU (Central Processing Unit) or a GPU (Graphics Processing Unit). The memory 92 is, for example, a memory such as RAM (Random Access Memory) or ROM (Read Only Memory). The storage 93 is, for example, a storage apparatus such as an HDD (Hard Disk Drive), an SSD (Solid State Drive), or a memory card. The storage 93 may be a memory such as RAM or ROM.

The storage 93 stores programs for implementing the functions of the components included in the video quality estimation apparatuses 20, 20A, and 100. By executing each of these programs, the processor 91 implements the functions of the components included in the video quality estimation apparatuses 20, 20A, and 100. Here, the processor 91 may execute the above programs after reading them into the memory 92, or may execute them without reading them into the memory 92. The memory 92 and the storage 93 also serve to store information and data held by the components of the video quality estimation apparatuses 20, 20A, and 100.

Further, the above program can be stored and provided to a computer (including the computer 90) using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc ROM), CD-R (CD-Recordable), CD-R/W (CD-Rewritable), and semiconductor memories (such as mask ROM, PROM (programmable ROM), EPROM (erasable PROM), flash ROM, RAM.

The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The input/output interface 94 is connected to a display apparatus 941, an input apparatus 942, a sound output apparatus 943, etc. The display apparatus 941 is an apparatus that displays a screen corresponding to drawing data processed by the processor 91, such as an LCD (Liquid Crystal Display), CRT (Cathode Ray Tube) display, or monitor. The input apparatus 942 is an apparatus that accepts the operator’s operational input, such as a keyboard, mouse, and touch sensor. The display apparatus 941 and the input apparatus 942 may be integrated and implemented as a touch panel. The sound output apparatus 943 is an apparatus such as a speaker that outputs sound corresponding to the sound data processed by the processor 91.

The communication interface 95 transmits and receives data to and from an external apparatus. For example, the communication interface 95 communicates with the external apparatus via a wired or wireless channel.

Although the present disclosure has been described above with reference to the example embodiments, the disclosure is not limited to the example embodiments described above. Various changes in the configuration and details of the present disclosure may be made that would be understandable to a person skilled in the art within the scope of the present disclosure.

The whole or part of the example embodiments disclosed above can be described as, but not limited to, the following supplementary notes.

### (Supplementary Note 1)

A video quality estimation apparatus comprising:
a first collection unit configured to collect network quality information about a network pertaining to distribution of a video;
a second collection unit configured to collect video quality information about the video; and
an estimation unit configured to estimate a first bit rate corresponding to a resolution of the video based on the network quality information and the video quality information.

### (Supplementary Note 2)

The video quality estimation apparatus according to Supplementary note 1, wherein
the video quality information includes the resolution of the video and a second bit rate corresponding to the resolution, and
the estimation unit specifies a value to be added to the second bit rate corresponding to the resolution of the video included in the video quality information, and estimates the first bit rate corresponding to the resolution of the video based on the network quality information and the video quality information.

### (Supplementary Note 3)

The video quality estimation apparatus according to Supplementary note 2, wherein

the estimation unit adds a predetermined bit rate as the value to be added to the second bit rate corresponding to the resolution of the video included in the video quality information when the resolution of the video included in the video quality information is lower than a standard resolution.

### (Supplementary Note 4)

The video quality estimation apparatus according to Supplementary note 2 or 3, wherein
the network quality information includes a frame loss rate of the network,
the estimation unit calculates a bit rate required for retransmitting video data due to a frame loss based on the frame loss rate, and
the estimation unit adds the bit rate required for retransmitting the video data as the value to be added to the second bit rate corresponding to the resolution of the video included in the video quality information.

### (Supplementary Note 5)

The video quality estimation apparatus according to any one of Supplementary notes 2 to 4, wherein
the estimation unit calculates a bit rate required for transmitting a header based on a size of the header of the video data packet, and
the estimation unit adds the bit rate required for transmitting the header as the value to be added to the second bit rate corresponding to the resolution of the video included in the video quality information.

### (Supplementary Note 6)

The video quality estimation apparatus according to any one of Supplementary notes 2 to 5, wherein
the network quality information includes an average throughput of the network, and
the estimation unit adjusts the first bit rate to a value of the average throughput when the first bit rate estimated to correspond to the resolution of the video is higher than the average throughput.

### (Supplementary Note 7)

The video quality estimation apparatus according to any one of Supplementary notes 1 to 6, further comprising:

a display unit configured to display the first bit rate corresponding to the resolution of the video estimated by the estimation unit.

### (Supplementary Note 8)

The video quality estimation apparatus according to any one of Supplementary notes 2 to 6, wherein

the estimation unit estimates the first bit rate corresponding to each of one or more of the resolutions of one or more of the videos, and estimates a resolution distribution indicating a ratio of each resolution corresponding to the first bit rate based on a result of the estimation.

### (Supplementary Note 9)

The video quality estimation apparatus according to Supplementary note 8, further comprising:

a display unit, wherein
the network quality information includes the average throughput of the network for each of a plurality of areas,
the estimation unit estimates the resolution distribution for each of the plurality of areas, estimates an average resolution based on the estimated resolution distribution and the average throughput, and
the display unit displays each of the plurality of areas on a map and displays the average resolution of each of the plurality of areas.

### (Supplementary Note 10)

The video quality estimation apparatus according to Supplementary note 9, wherein
a band of a network slice is allocated to each of the plurality of areas, and
when there is an area where the estimated average resolution is lower than a target resolution among the plurality of areas, the estimation unit increases the band of the network slice allocated to the area.

### (Supplementary Note 11)

A video quality estimation method comprising:
collecting network quality information about a network pertaining to distribution of a video;
collecting video quality information about the video; and
estimating a first bit rate corresponding to a resolution of the video based on the network quality information and the video quality information.

### (Supplementary Note 12)

The video quality estimation method according to Supplementary note 11, wherein
the video quality information includes the resolution of the video and a second bit rate corresponding to the resolution, and
in the estimating, a value to be added to the second bit rate corresponding to the resolution of the video included in the video quality information is specified, and the first bit rate corresponding to the resolution of the video is estimated based on the network quality information and the video quality information.

### (Supplementary Note 13)

The video quality estimation method according to Supplementary note 12, wherein

in the estimating, a predetermined bit rate as the value to be added is added to the second bit rate corresponding to the resolution of the video included in the video quality information when the resolution of the video included in the video quality information is lower than a standard resolution.

### (Supplementary Note 14)

The video quality estimation method according to Supplementary note 12 or 13, wherein
the network quality information includes a frame loss rate of the network,
in the estimating, a bit rate required for retransmitting video data due to a frame loss is calculated based on the frame loss rate, and
in the estimating, the bit rate required for retransmitting the video data as the value to be added is added to the second bit rate corresponding to the resolution of the video included in the video quality information.

### (Supplementary Note 15)

The video quality estimation method according to any one of Supplementary notes 12 to 14, wherein
in the estimating, a bit rate required for transmitting a header based on a size of the header of the video data packet is calculated, and
in the estimating, the bit rate required for transmitting the header as the value to be added is added to the second bit rate corresponding to the resolution of the video included in the video quality information.

### (Supplementary Note 16)

The video quality estimation method according to any one of Supplementary notes 12 to 15, wherein
the network quality information includes an average throughput of the network, and
in the estimating, the first bit rate is adjusted to a value of the average throughput when the first bit rate estimated to correspond to the resolution of the video is higher than the average throughput.

### (Supplementary Note 17)

The video quality estimation method according to any one of Supplementary notes 11 to 16, further comprising:

displaying the first bit rate corresponding to the resolution of the video estimated in the estimating.

### (Supplementary Note 18)

The video quality estimation method according to any one of Supplementary notes 12 to 16, wherein

in the estimating, the first bit rate corresponding to each of one or more of the resolutions of one or more of the videos is estimated, and a resolution distribution indicating a ratio of each resolution corresponding to the first bit rate based on a result of the estimation is estimated.

### (Supplementary Note 19)

The video quality estimation method according to Supplementary note 18, wherein
the network quality information includes the average throughput of the network for each of a plurality of areas,
in the estimating, the resolution distribution is estimated for each of the plurality of areas, and an average resolution is estimated based on the estimated resolution distribution and the average throughput, and
the video quality estimation method further comprises:
   displaying each of the plurality of areas on a map and displaying the average resolution of each of the plurality of areas.

### (Supplementary Note 20)

The video quality estimation method according to Supplementary note 19, wherein
a band of a network slice is allocated to each of the plurality of areas, and
in the estimating, when there is an area where the estimated average resolution is lower than a target resolution among the plurality of areas, the band of the network slice allocated to the area is increased.

### (Supplementary Note 21)

A video quality estimation system comprising:
a first collection unit configured to collect network quality information about a network pertaining to distribution of a video;
a second collection unit configured to collect video quality information about the video; and
an estimation unit configured to estimate a first bit rate corresponding to a resolution of the video based on the network quality information and the video quality information.

### (Supplementary Note 22)

The video quality estimation system according to Supplementary note 21, wherein
the video quality information includes the resolution of the video and a second bit rate corresponding to the resolution, and
the estimation unit specifies a value to be added to the second bit rate corresponding to the resolution of the video included in the video quality information, and estimates the first bit rate corresponding to the resolution of the video based on the network quality information and the video quality information.

### (Supplementary Note 23)

The video quality estimation system according to Supplementary note 22, wherein

the estimation unit adds a predetermined bit rate as the value to be added to the second bit rate corresponding to the resolution of the video included in the video quality information when the resolution of the video included in the video quality information is lower than a standard resolution.

### (Supplementary Note 24)

The video quality estimation system according to Supplementary note 22 or 23, wherein
the network quality information includes a frame loss rate of the network,
the estimation unit calculates a bit rate required for retransmitting video data due to a frame loss based on the frame loss rate, and
the estimation unit adds the bit rate required for retransmitting the video data as the value to be added to the second bit rate corresponding to the resolution of the video included in the video quality information.

### (Supplementary Note 25)

The video quality estimation system according to any one of Supplementary notes 22 to 24, wherein
the estimation unit calculates a bit rate required for transmitting a header based on a size of the header of the video data packet, and
the estimation unit adds the bit rate required for transmitting the header as the value to be added to the second bit rate corresponding to the resolution of the video included in the video quality information.

### (Supplementary Note 26)

The video quality estimation system according to any one of Supplementary notes 22 to 25, wherein
the network quality information includes an average throughput of the network, and
the estimation unit adjusts the first bit rate to a value of the average throughput when the first bit rate estimated to correspond to the resolution of the video is higher than the average throughput.

### (Supplementary Note 27)

The video quality estimation system according to any one of Supplementary notes 21 to 26, further comprising:

a display unit configured to display the first bit rate corresponding to the resolution of the video estimated by the estimation unit.

### (Supplementary Note 28)

The video quality estimation system according to any one of Supplementary notes 22 to 26, wherein

the estimation unit estimates the first bit rate corresponding to each of one or more of the resolutions of one or more of the videos, and estimates a resolution distribution indicating a ratio of each resolution corresponding to the first bit rate based on a result of the estimation.

### (Supplementary Note 29)

The video quality estimation system according to Supplementary note 28, further comprising:

a display unit, wherein
the network quality information includes the average throughput of the network for each of a plurality of areas,
the estimation unit estimates the resolution distribution for each of the plurality of areas, estimates an average resolution based on the estimated resolution distribution and the average throughput, and
the display unit displays each of the plurality of areas on a map and displays the average resolution of each of the plurality of areas.

### (Supplementary Note 30)

The video quality estimation system according to Supplementary note 29, wherein
a band of a network slice is allocated to each of the plurality of areas, and
when there is an area where the estimated average resolution is lower than a target resolution among the plurality of areas, the estimation unit increases the band of the network slice allocated to the area.

Reference Signs List

| | |
|---|---|
| 10 | TERMINAL |
| 20,20A | VIDEO QUALITY ESTIMATION APPARATUS |
| 21 | NETWORK QUALITY INFORMATION COLLECTION UNIT |
| 22 | NETWORK QUALITY INFORMATION DB |
| 23 | VIDEO QUALITY INFORMATION COLLECTION UNIT |
| 24 | VIDEO QUALITY INFORMATION DB |
| 25 | VIDEO QUALITY ESTIMATION UNIT |
| 251 | POLICY INFLUENCE CALCULATION UNIT |
| 252 | LOSS INFLUENCE CALCULATION UNIT |
| 253 | OVERHEAD CALCULATION UNIT |
| 254 | RESOLUTION DISTRIBUTION ESTIMATION UNIT |
| 26 | DISPLAY UNIT |
| 30 | BASE STATION |
| 40 | MNO NETWORK |
| 41 | S-GW |
| 42 | P-GW |
| 43 | MME |
| 44 | HSS |
| 50 | MVNO NETWORK |
| 51 | P-GW |
| 52 | PCRF |
| 53 | AUTHENTICATION SERVER |
| 60 | NETWORK TUNNEL |
| 70 | INTERNET |
| 80 | VIDEO DISTRIBUTION SERVER |
| 90 | COMPUTER |
| 91 | PROCESSOR |
| 92 | MEMORY |
| 93 | STORAGE |
| 94 | INPUT/OUTPUT INTERFACE |
| 941 | DISPLAY APPARATUS |
| 942 | INPUT APPARATUS |
| 943 | SOUND OUTPUT APPARATUS |
| 95 | COMMUNICATION INTERFACE |
| 100 | VIDEO QUALITY ESTIMATION APPARATUS |
| 101 | FIRST COLLECTION UNIT |
| 102 | SECOND COLLECTION UNIT |
| 103 | ESTIMATION UNIT |
| 110 | NETWORK |

What is claimed is:

1. A video quality estimation apparatus comprising:
at least one memory storing instructions, and
at least one processor configured to execute the instructions to;
collect network quality information about a network pertaining to distribution of a video;
collect video quality information about the video; and
estimate a first bit rate corresponding to a resolution of the video based on the network quality information and the video quality information.

2. The video quality estimation apparatus according to claim 1, wherein
the video quality information includes the resolution of the video and a second bit rate corresponding to the resolution, and
the at least one processor is further configured to execute the instructions to specify a value to be added to the second bit rate corresponding to the resolution of the video included in the video quality information, and estimate the first bit rate corresponding to the resolution of the video based on the network quality information and the video quality information.

3. The video quality estimation apparatus according to claim 2, wherein
the at least one processor is further configured to execute the instructions to add a predetermined bit rate as the value to be added to the second bit rate corresponding to the resolution of the video included in the video quality information when the resolution of the video included in the video quality information is lower than a standard resolution.

4. The video quality estimation apparatus according to claim 2, wherein
the network quality information includes a frame loss rate of the network,
the at least one processor is further configured to execute the instructions to;
calculate a bit rate required for retransmitting video data due to a frame loss based on the frame loss rate, and
add the bit rate required for retransmitting the video data as the value to be added to the second bit rate corresponding to the resolution of the video included in the video quality information.

5. The video quality estimation apparatus according to claim 2, wherein
the at least one processor is further configured to execute the instructions to;
calculate a bit rate required for transmitting a header based on a size of the header of the video data packet, and
add the bit rate required for transmitting the header as the value to be added to the second bit rate corresponding to the resolution of the video included in the video quality information.

6. The video quality estimation apparatus according to claim 1, further comprising:
a display unit configured to display the first bit rate corresponding to the resolution of the video estimated by the at least one processor.

7. A video quality estimation method comprising:
collecting network quality information about a network pertaining to distribution of a video;
collecting video quality information about the video; and
estimating a first bit rate corresponding to a resolution of the video based on the network quality information and the video quality information.

8. The video quality estimation method according to claim 7, wherein
the video quality information includes the resolution of the video and a second bit rate corresponding to the resolution, and
in the estimating, a value to be added to the second bit rate corresponding to the resolution of the video included in the video quality information is specified, and a bit rate corresponding to the resolution of the video is estimated based on the network quality information and the video quality information.

9. The video quality estimation method according to claim 8, wherein
in the estimating, a predetermined bit rate as the value to be added is added to the second bit rate corresponding to the resolution of the video included in the video quality information when the resolution of the video included in the video quality information is lower than a standard resolution.

10. The video quality estimation method according to claim 8, wherein
the network quality information includes a frame loss rate of the network,
in the estimating, a bit rate required for retransmitting video data due to a frame loss is calculated based on the frame loss rate, and
in the estimating, the bit rate required for retransmitting the video data as the value to be added is added to the second bit rate corresponding to the resolution of the video included in the video quality information.

11. The video quality estimation method according to claim 8, wherein
in the estimating, a bit rate required for transmitting a header based on a size of the header of the video data packet is calculated, and
in the estimating, the bit rate required for transmitting the header as the value to be added is added to the second bit rate corresponding to the resolution of the video included in the video quality information.

12. The video quality estimation method according to claim 7, further comprising:
displaying the first bit rate corresponding to the resolution of the video estimated in the estimating.

13. A video quality estimation system comprising:
a first collection unit configured to collect network quality information about a network pertaining to distribution of a video;
a second collection unit configured to collect video quality information about the video; and
an estimation unit configured to estimate a first bit rate corresponding to a resolution of the video based on the network quality information and the video quality information.

14. The video quality estimation system according to claim 13, wherein
the video quality information includes the resolution of the video and a second bit rate corresponding to the resolution, and
the estimation unit specifies a value to be added to the second bit rate corresponding to the resolution of the video included in the video quality information, and estimates the first bit rate corresponding to the resolution of the video based on the network quality information and the video quality information.

15. The video quality estimation system according to claim 14, wherein
the estimation unit adds a predetermined bit rate as the value to be added to the second bit rate corresponding to the resolution of the video included in the video quality information when the resolution of the video included in the video quality information is lower than a standard resolution.

16. The video quality estimation system according to claim 14, wherein
the network quality information includes a frame loss rate of the network,
the estimation unit calculates a bit rate required for retransmitting video data due to a frame loss based on the frame loss rate, and
the estimation unit adds the bit rate required for retransmitting the video data as the value to be added to the second bit rate corresponding to the resolution of the video included in the video quality information.

17. The video quality estimation system according to claim 14, wherein
the estimation unit calculates a bit rate required for transmitting a header based on a size of the header of the video data packet, and
the estimation unit adds the bit rate required for transmitting the header as the value to be added to the second bit rate corresponding to the resolution of the video included in the video quality information.

18. The video quality estimation system according to claim 13, further comprising:
a display unit configured to display the first bit rate corresponding to the resolution of the video estimated by the estimation unit.
